(19) United States
(12) Patent Application Publication
(10) Pub. No.: US 2025/0373422 A1
(43) Pub. Date: Dec. 4, 2025

(54) DUPLICATE SECURITY ASSOCIATION MANAGER

(71) Applicant: Dell Products L.P., Round Rock, TX (US)

(72) Inventors: Cristian Manuel, Escondido, CA (US); Gregory W. Lazar, Upton, MA (US)

(21) Appl. No.: 18/677,699

(22) Filed: May 29, 2024

(51) Int. Cl. H04L 9/08

(52) U.S. Cl. CPC H04L 9/088

(57) ABSTRACT

One example method includes receiving, at a first computing system from a secure association (SA) service, a first event that indicates that a first SA encryption tunnel has been generated that includes the first computing system, the first SA encryption tunnel including encryption and decryption keys assigned to an IP address of the first computing system. In response to receiving the first event, requesting from the SA service a first SA encryption tunnel list that lists all SA encryption tunnels existing in a computing environment. Comparing the first SA encryption tunnel with the SA encryption tunnels included in the first SA encryption tunnel list. Based on the comparison, determining whether the first SA encryption tunnel is a duplicate of one or more of the SA encryption tunnels included in the first SA encryption tunnel list.

### COPYRIGHT AND MASK WORK NOTICE

A portion of the disclosure of this patent document contains material which is subject to (copyright or mask work) protection. The (copyright or mask work) owner has no objection to the facsimile reproduction by anyone of the patent document or the patent disclosure, as it appears in the Patent and Trademark Office patent file or records, but otherwise reserves all (copyright or mask work) rights whatsoever.

### TECHNOLOGICAL FIELD OF THE DISCLOSURE

Embodiments disclosed herein generally relate to network traffic encryption tunnels. More particularly, at least some embodiments relate to systems, hardware, software, computer-readable media, and methods for removing any duplicate network traffic encryption tunnels.

### BACKGROUND

Network data packets are transmitted and received between two computing systems. To facilitate this network packets, one or more traffic policies are installed in the kernel of the computing systems that define encryption rules for transmitting the network data packets. Each traffic policy includes a source IP address, a destination IP address, and an action to encrypt or not to encrypt. When the kernel sees a network data packet matching the preconfigured traffic policy, the kernel will apply the desired action on the network data packet.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIGS. 1A-1C disclose aspects of a computing system environment for implementing the embodiments disclosed herein.

FIG. 2 discloses aspects of an embodiment for generating an SA encryption tunnel initiated by a local computing system.

FIG. 3 discloses aspects of an embodiment for generating an SA encryption tunnel initiated by a remote computing system.

FIGS. 4A-4D disclose aspects of a duplicate SA manager according to the embodiments disclosed herein.

FIG. 5 discloses a method according to the embodiments disclosed herein.

FIG. 6 discloses an example computing entity configured to perform any of the disclosed methods, processes, and operations.

### DETAILED DESCRIPTION OF SOME EXAMPLE EMBODIMENTS

Embodiments disclosed herein generally relate to network traffic encryption tunnels. More particularly, at least some embodiments relate to systems, hardware, software, computer-readable media, and methods for removing any duplicate network traffic encryption tunnels.

One example method includes receiving, at a first computing system from a secure association (SA) service, a first event that indicates that a first SA encryption tunnel has been generated that includes the first computing system, the first SA encryption tunnel including encryption and decryption keys assigned to an IP address of the first computing system. In response to receiving the first event, requesting from the SA service a first SA encryption tunnel list that lists all SA encryption tunnels existing in a computing environment. Comparing the first SA encryption tunnel with the SA encryption tunnels included in the first SA encryption tunnel list. Based on the comparison, determining whether the first SA encryption tunnel is a duplicate of one or more of the SA encryption tunnels included in the first SA encryption tunnel list.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, the embodiments disclosed herein provide improvements to the operating of the computing system. For example, the embodiments disclosed herein provide a mechanism that is useful in correcting the duplicate SA problem. By correcting the duplicate SA problem, there is a reduction in the loss of network packages being transmitted and received between two computing systems. In addition, memory resources are saved as a computing system will not having two SA encryption tunnels and their associated encryption and decryption keys stored in the computing system kernel.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

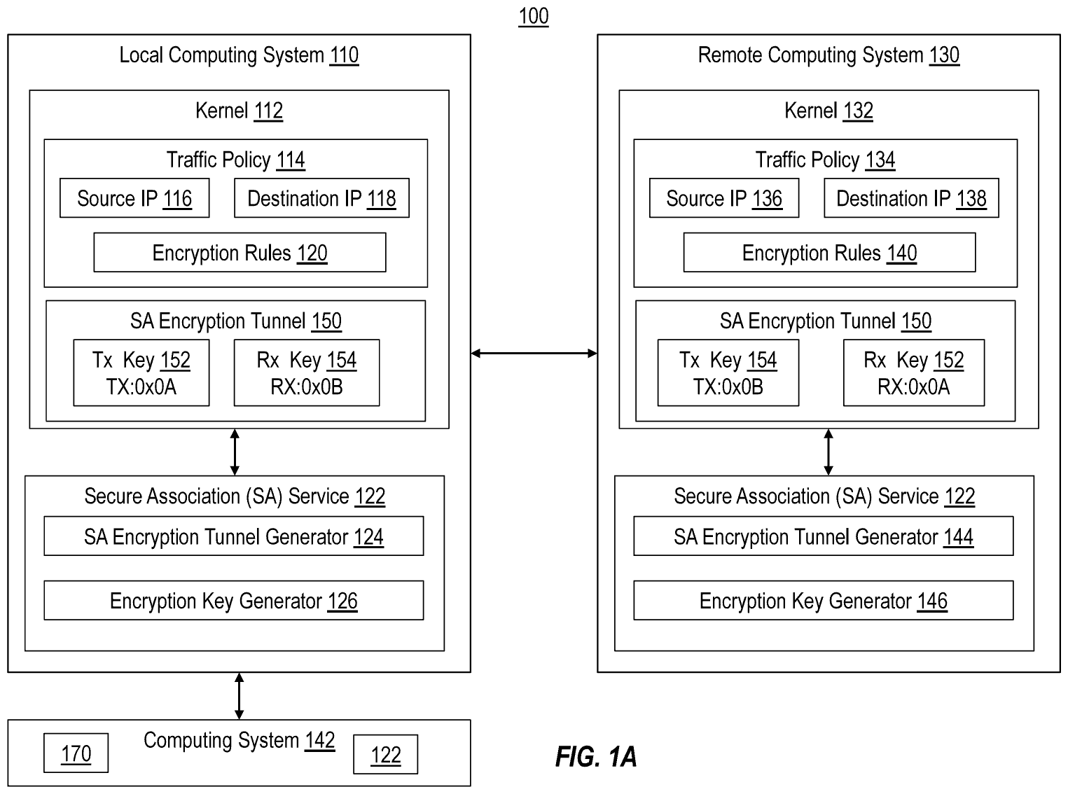

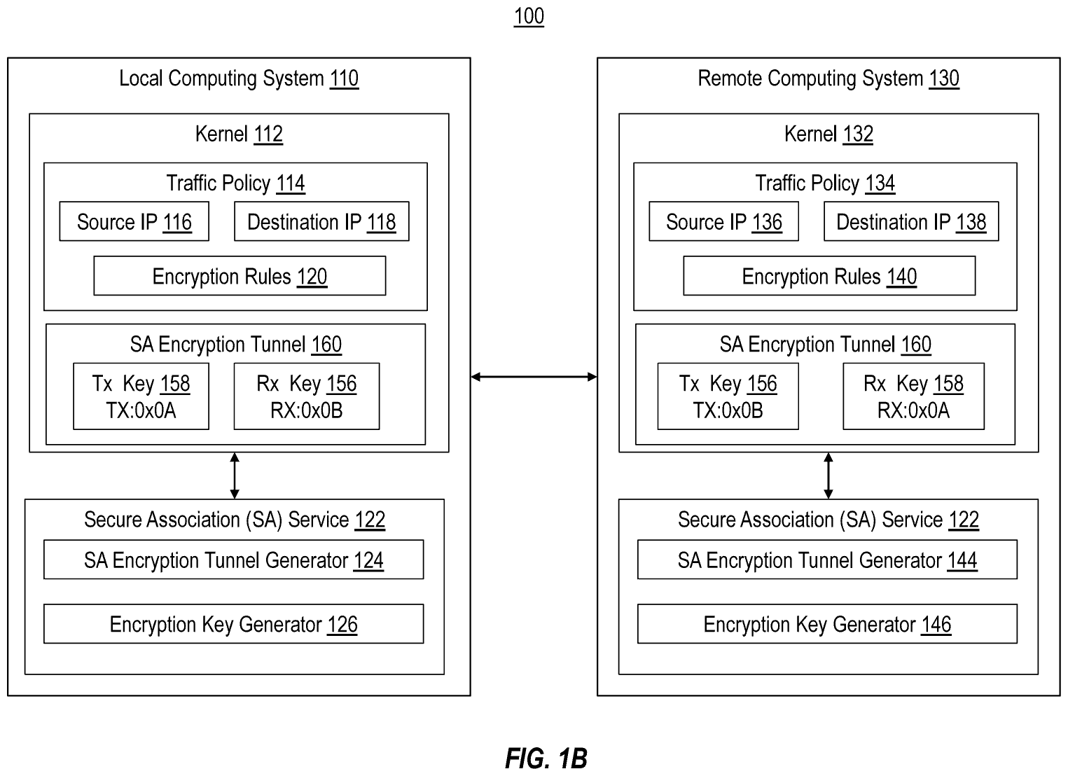

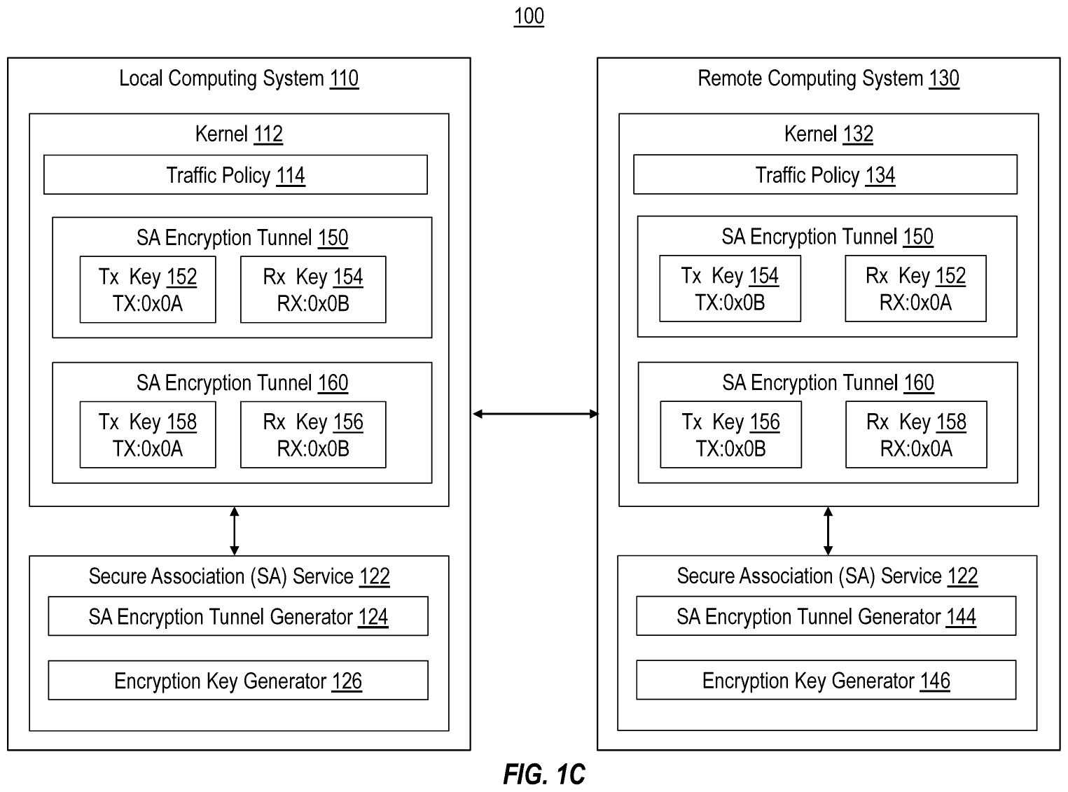

FIG. 1A illustrates an embodiment of a computing environment 100 that includes a local computing system 110 and a remote computing system 130, which may be any reasonable computing systems. In operation, the local computing system 110 is able to send network packets to the remote computing system 130. Accordingly, the local computing system 110 includes a traffic policy 114 that is stored in the kernel 112 of the computing system. The traffic policy includes a source IP address 116 and a destination IP address 118. For example, in the embodiment the source IP address 116 would be the IP address of the local computing system 110 and the destination IP address 118 would be the IP address of the remote computing system 130. The traffic policy 114 also includes one or more encryption rules 120. The encryption rules 120 specify whether the network packets sent between the computing systems 110 and 130 should be encrypted or not.

The local computing system 110 is also able to send network packets to a remote computing system 142. Accordingly, the local computing system 110 would also include a non-illustrated traffic policy for the remote computing system 142 that would specify the source and destination IP addresses and the encryption rules for network packets sent between the computing systems 110 and 142. Although not illustrated, it will be appreciated that the local computing system 110 is also able to send network packets to other non-illustrated remote computing systems.

The local computing system 110 also includes or is otherwise has access to a secure association (SA) service 122. In some embodiments, the SA service 122 may be Strongswan. The SA service 122 includes an SA encryption tunnel generator 124 that in operation is able to create an SA encryption tunnel between the computing systems 110 and 130 (and between the computing systems 110 and 142) as will be explained in more detail to follow and to push that SA encryption tunnel to the kernel 112. It will be noted that the SA encryption tunnel generator 124 represents all the processes and functional modules used by the SA service 122 when generating an SA encryption tunnel.

In addition, the SA service 122 includes or otherwise has access to an encryption key generator 126. The encryption key generator 126 may use any known encryption protocol when generating the encryption keys. Accordingly, the embodiments disclosed herein are not limited to any specific type of encryption protocol implemented by the encryption key generator 126.

The remote computing system 130 is also able to send network packets to the local computing system 110. Accordingly, the computing system includes a traffic policy 134 that is stored in the computing system kernel 132. The traffic policy includes a source IP address 136 and a destination IP address 138. For example, in the embodiment the source IP address 136 would be the IP address of the remote computing system 130 and the destination IP address 138 would be the IP address of the local computing system 110. The traffic policy 134 also includes one or more encryption rules 140. The encryption rules 140 specify whether the network packets sent between the computing systems 130 and 110 should be encrypted or not. The remote computing system 130 also includes or is otherwise associated with the SA service 122. The computing system 142 also includes or is otherwise associated with the SA service 122.

In operation, when the kernel 112 sees a network packet that matches the traffic policy 114, the kernel 112 will apply the desired action to the packet. For example, the source IP address 116 and the destination IP address 118 will specify that the network packet is to be transmitted between the local computing system 110 and the remote computing system 130. In addition, if in the embodiment the encryption rules 120 specify that that there is no encryption to do, the kernel 112 will route the network packet normally.

However, if in the embodiment the encryption rules 120 specify that that there is encryption to do, the kernel 112 will use an existing SA encryption tunnel if one already exists to encrypt the network packet. If there is no existing SA encryption tunnel available to the kernel 112, the SA service 122 is able to generate an SA encryption tunnel using the SA encryption tunnel generator 124. For example, as illustrated in FIG. 1A, an SA encryption tunnel 150 can be used if already existing or it can be generated.

As also illustrated, the SA encryption tunnel 150 includes a TX encryption key 152 in the kernel 112 and its corresponding RX decryption key 152 in the kernel 132. The TX encryption key 152 and the RX decryption key 152 allow the kernel 112 to encrypt a network package prior to transmitting and the kernel 132 to decrypt the received network package. Likewise, the SA encryption tunnel 150 includes a TX encryption key 154 in the kernel 132 and its corresponding RX decryption key 154 in the kernel 112. The TX encryption key 154 and the RX decryption key 154 allow the kernel 132 to encrypt a network package prior to transmitting and the kernel 112 to decrypt the received network package.

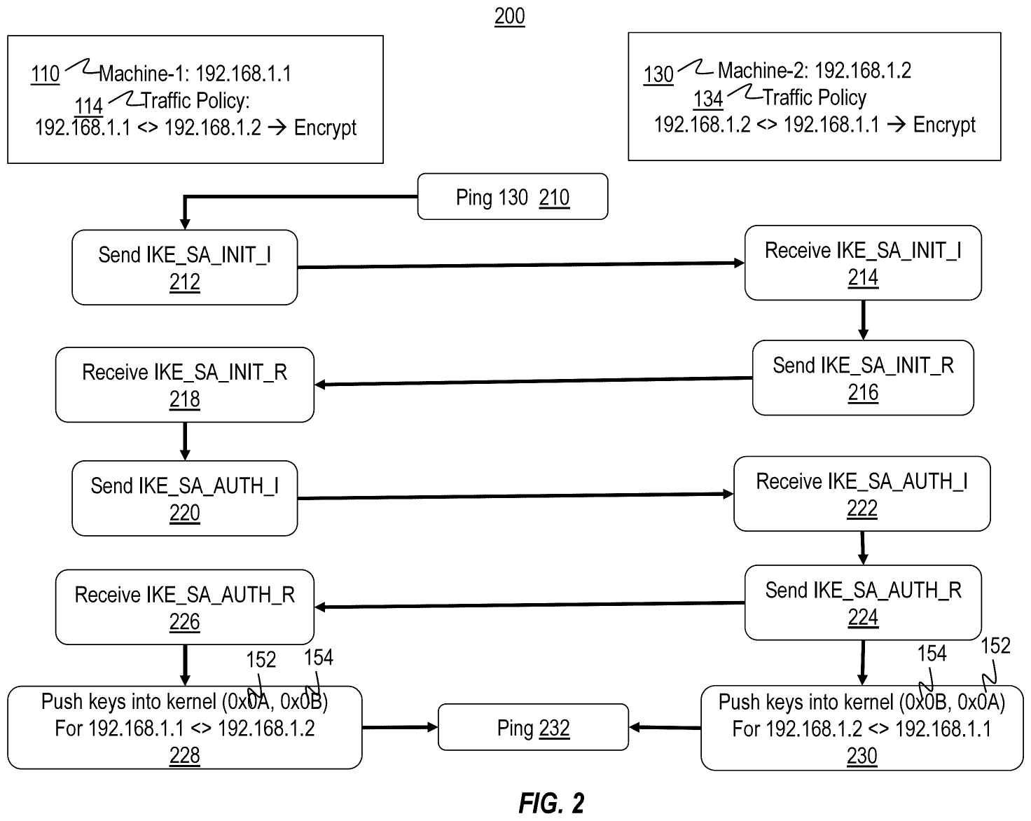

FIG. 2 illustrates an embodiment of the process 200 by which the SA encryption tunnel 150 is generated between the computing systems 110 and 130 by the SA service 122. As illustrated, FIG. 2 shows the name and IP address (192.168.1.1) of the of the local computing system 110 and the name and IP address (192.168.1.2) of the remote computing system 130. In addition, the figure shows that the local computing system 110 includes the traffic policy 114 including the source and destination IP addresses and that the remote computing system 130 includes the traffic policy 134 including the source and destination IP addresses.

At step 210, the local computing system 110 pings the remote computing system 130, thus initiating an Internet Key Exchange (IKEv2) process that generates the SA encryption tunnel 150. Since the local computing system 110 initiates the process, in the process it is the “initiator”. Remote computing system 130 is the “responder” in the process.

At step 212, the local computing system 110 sends an IKE_SA_INIT_I request to the remote computing system 130, which is received at step 214. At step 216, the remote computing system 130 sends an IKE_SA_INIT_R response to the local computing system 110, which is received at step 218. During the INIT exchange, the computing systems 110 and 130 derive a shared secret that is used to derive encryption and decryption keys.

An authentication exchange is then performed. At step 220, the local computing system 110 sends an IKE_SA_AUTH_I request to the remote computing system 130, which is received at step 222. At step 224, the remote computing system 130 sends an IKE_SA_AUTH_R response to the local computing system 110, which is received at step 226.

During the process of generating the SA encryption tunnel 150, the TX encryption key 152 and the RX decryption key 152 and the TX encryption key 154 and the RX decryption key 154 are generated. At step 228, the TX encryption key 152 and the RX decryption key 154 are pushed by the SA service 122 to the kernel 112. At step 230, the TX encryption key 154 and the RX decryption key 152 are pushed by the SA service 122 to the kernel 132. At step 232, the local computing system 110 and the remote computing system 130 are able to send encrypted network packages to each other and then to decrypt the encrypted network packages.

FIG. 1B illustrates an alternative embodiment of the computing environment 100 that includes the local computing system 110 and the remote computing system 130. In this embodiment, the remote computing system 130 initiates the transmission of the network packets. That is, when the kernel 132 sees a network packet that matches the traffic policy 134, the kernel 132 will apply the desired action to the packet. For example, the source IP address 136 and the destination IP address 138 will specify that the network packet is to be transmitted between the remote computing system 130 and the local computing system 110. In addition, if in the embodiment the encryption rules 140 specify that that there is no encryption to do, the kernel 132 will route the network packet normally.

However, if in the embodiment the encryption rules 140 specify that that there is encryption to do, the kernel 132 will use an existing SA encryption tunnel if one already exists to encrypt the network packet. If there is no existing SA encryption tunnel available to the kernel 132, the SA service 122 is able to generate an SA encryption tunnel using the SA encryption tunnel generator 124. For example, as illustrated in FIG. 1B, an SA encryption tunnel 160 can be used if already existing or it can be generated.

As also illustrated, the SA encryption tunnel 160 includes a TX encryption key 156 in the kernel 132 and its corresponding RX decryption key 156 in the kernel 112. The TX encryption key 156 and the RX decryption key 156 allow the kernel 132 to encrypt a network package prior to transmitting and the kernel 112 to decrypt the received network package. Likewise, the SA encryption tunnel 160 includes a TX encryption key 158 in the kernel 112 and its corresponding RX decryption key 158 in the kernel 132. The TX encryption key 158 and the RX decryption key 158 allow the kernel 112 to encrypt a network package prior to transmitting and the kernel 132 to decrypt the received network package.

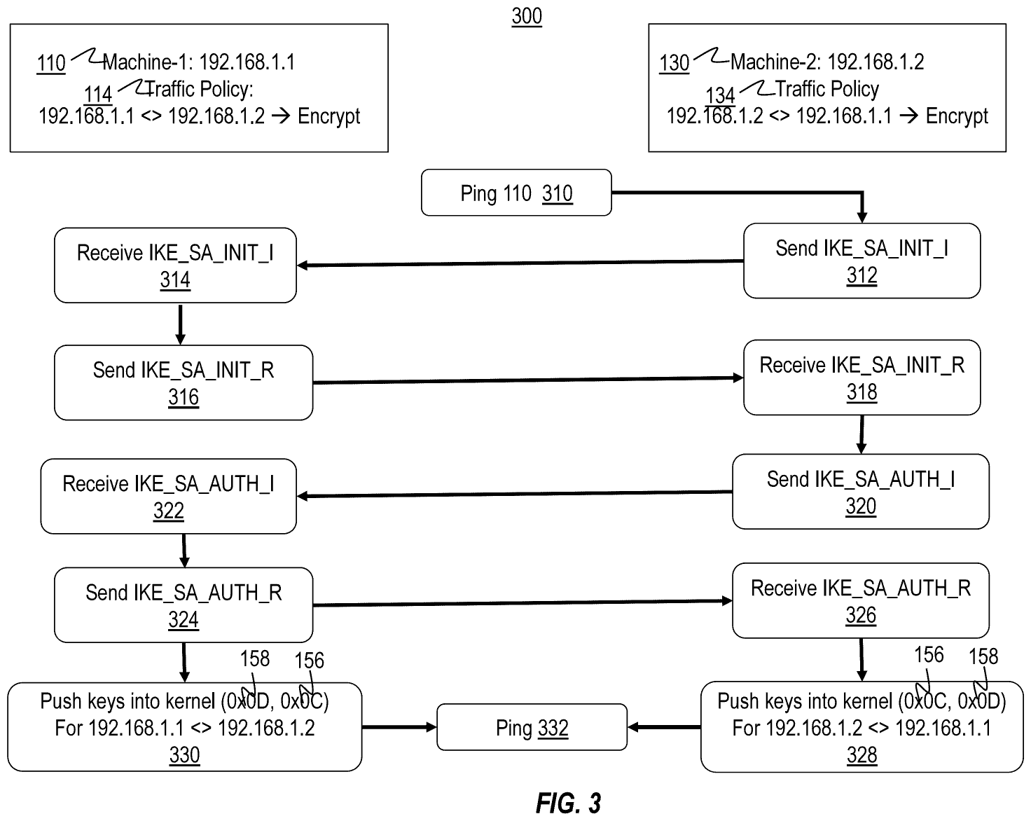

FIG. 3 illustrates an embodiment of the process 300 used by which the SA encryption tunnel 160 is generated between the computing systems 130 and 110 by the SA service 122. As illustrated, FIG. 3 shows the name and IP address (192.168.1.1) of the of the local computing system 110 and the name and IP address (192.168.1.2) of the remote computing system 130. In addition, the figure shows that the local computing system 110 includes the traffic policy 114 including the source and destination IP addresses and that the remote computing system 130 includes the traffic policy 134 including the source and destination IP addresses.

At step 310, the remote computing system 130 pings the local computing system 110, thus initiating an Internet Key Exchange (IKEv2) process that generates the SA encryption tunnel 160. Since the remote computing system 130 initiates the process, in the process it is the “initiator”. Local computing system 110 is the “responder” in the process.

At step 312, the remote computing system 130 sends an IKE_SA_INIT_I request to the local computing system 110, which is received at step 314. At step 316, the local computing system 110 sends an IKE_SA_INIT_R response to the remote computing system 130, which is received at step 318. During the INIT exchange, the computing systems 130 and 110 derive a shared secret that is used to derive encryption and decryption keys.

An authentication exchange is then performed. At step 320, the remote computing system 130 sends an IKE_SA_AUTH_I request to the local computing system 110, which is received at step 322. At step 324, the local computing system 110 sends an IKE_SA_AUTH_R response to the remote computing system 130, which is received at step 326.

During the process of generating the SA encryption tunnel 160, the TX encryption key 156 and the RX decryption key 158 and the TX encryption key 158 and the RX decryption key 156 are generated. At step 328, the TX encryption key 156 and the RX decryption key 158 are pushed by the SA service 122 to the kernel 132. At step 330, the TX encryption key 158 and the RX decryption key 156 are pushed by the SA service 122 to the kernel 112. At step 332, the remote computing system 130 and the local computing system 110 are able to send encrypted network packages to each other and then to decrypt the encrypted network packages.

FIGS. 1A and 2 illustrate that the local computing system 110 in an embodiment is able to initiate the generation of the SA encryption tunnel 150 for use in sending encrypted network packets between the local computing system 110 and the remote computing system 130. In such embodiment, the local computing system 110 will use the TX encryption key 152 and the RX decryption key 154 and the remote computing system 130 will use the TX encryption key 154 and the RX decryption key 152.

FIGS. 1B and 3 illustrate that the remote computing system 130 in an embodiment is able to initiate the generation of the SA encryption tunnel 160 for use in sending encrypted network packets between the remote computing system 130 and the local computing system 110. In such embodiment, the remote computing system 130 will use the TX encryption key 156 and the RX decryption key 158 and the local computing system 110 will use the TX encryption key 158 and the RX decryption key 156.

However, in some embodiments a case arises where both the local computing system 110 and the remote computing system 130 try to ping each other and initiate an SA encryption tunnel at substantially the same time. For example, in one embodiment both computing systems try to ping each other and initiate an SA encryption within ¼ of a second of each other. In such case, the local computing system 110 and the remote computing system 130 may fail to detect that each is generating an SA encryption tunnel.

Thus, as illustrated in FIG. 1C, both the SA encryption tunnel 150 and the SA encryption tunnel 160 are generated. This results in two pairs of encryption/decryption keys being associated with a single IP address. For example, both the TX encryption keys 152 and 158 and both the RX decryption keys 154 and 156 are associated with the IP address of the local computing system 110. In addition, both the TX encryption keys 154 and 156 and both the RX decryption keys 152 and 158 are associated with the IP address of the remote computing system 130.

In such embodiment, it is uncertain which TX encryption key and which RX decryption key the kernels 112 and 132 will choose to use. For example, suppose that the kernel 112 chose to use the TX encryption key 152 and the RX decryption key 154 of the SA encryption tunnel 150 when communicating with the remote computing system 130. In addition, suppose that the kernel 132 chose to use the TX encryption key 156 and the RX decryption key 158 of the SA encryption tunnel 160 when communicating with the remote computing system 110. In such case, it is undefined if network packets will flow between the local computing system 110 and the remote computing system 130 since the computing systems are using different encryption and decryption keys. This is known as the duplicate SA problem. It is estimated that the duplicate SA problem has a 50% chance of showing up per SA encryption tunnel that is generated. Thus, there is the potential for complete traffic loss in 50% of the SA encryption tunnels that are generated if network packets do not flow when the duplicate SA problem occurs.

Advantageously, the embodiments disclosed herein provide a mechanism that is useful in correcting the duplicate SA problem. In the embodiments, a duplicate secure association (SA) manager is implemented. The duplicate SA manager is able to detect duplicate SA's and is then able to cause that the duplicate SA be deleted. In this way, any traffic loss between the computing systems 110 and 130 is minimized as will now be explained.

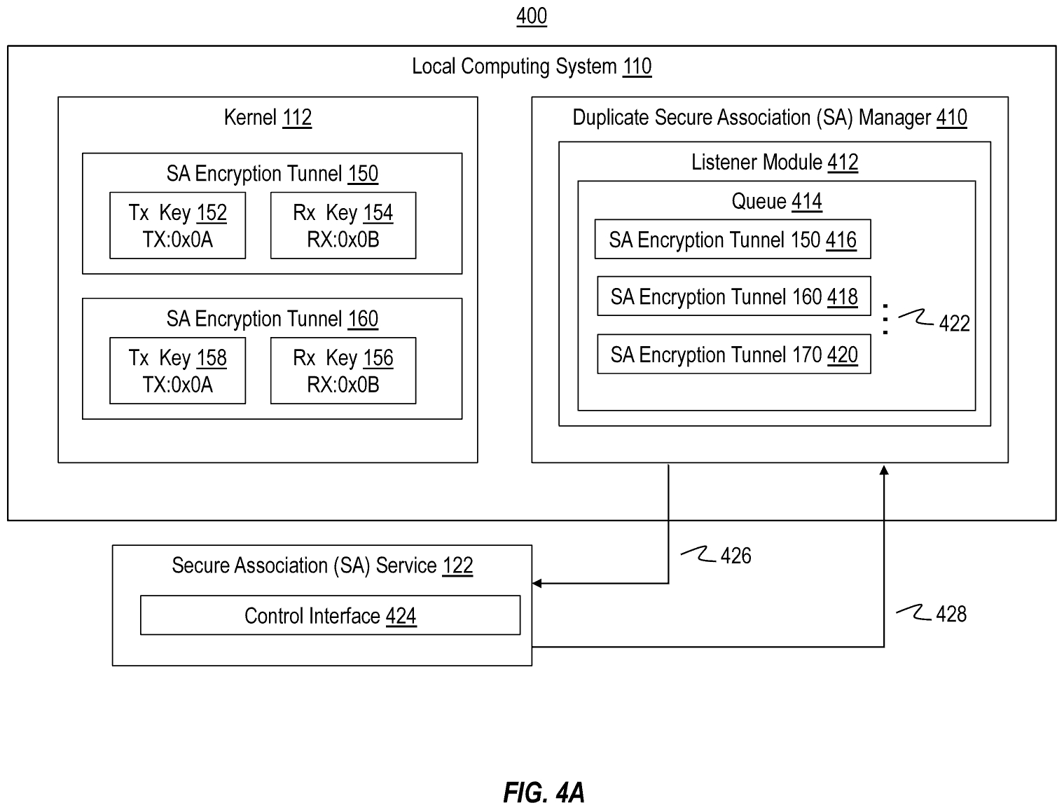

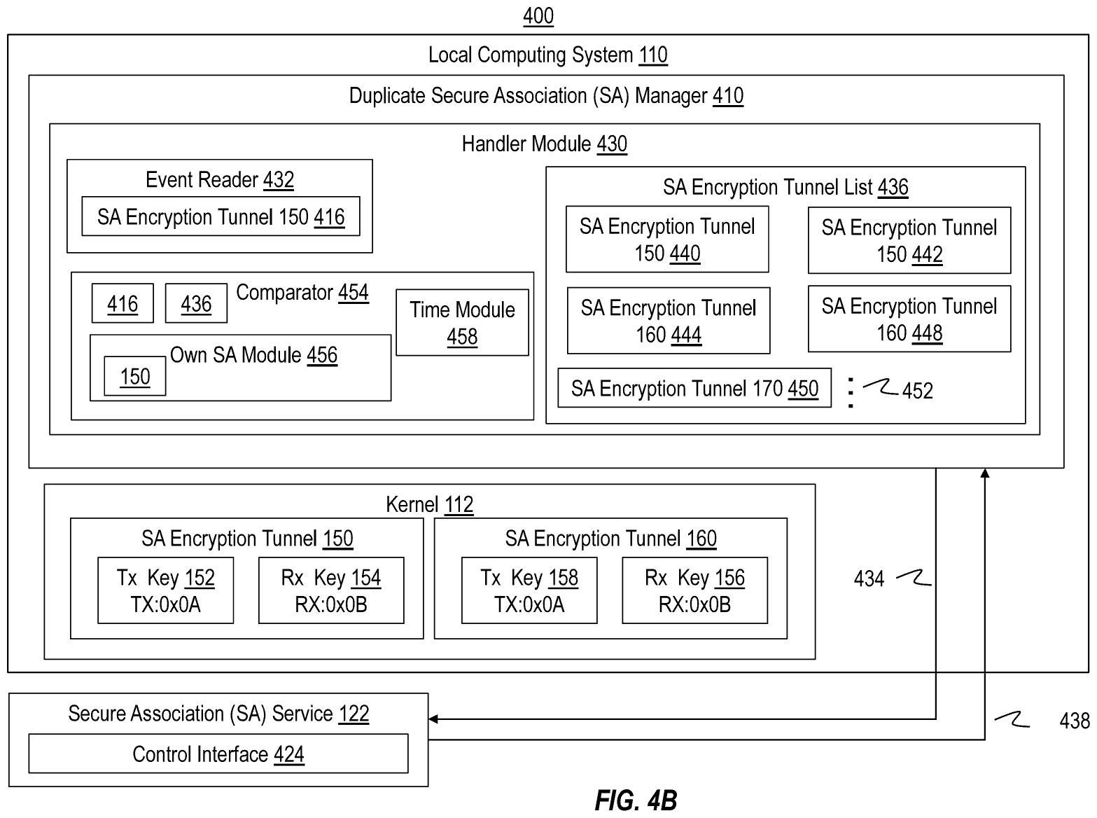

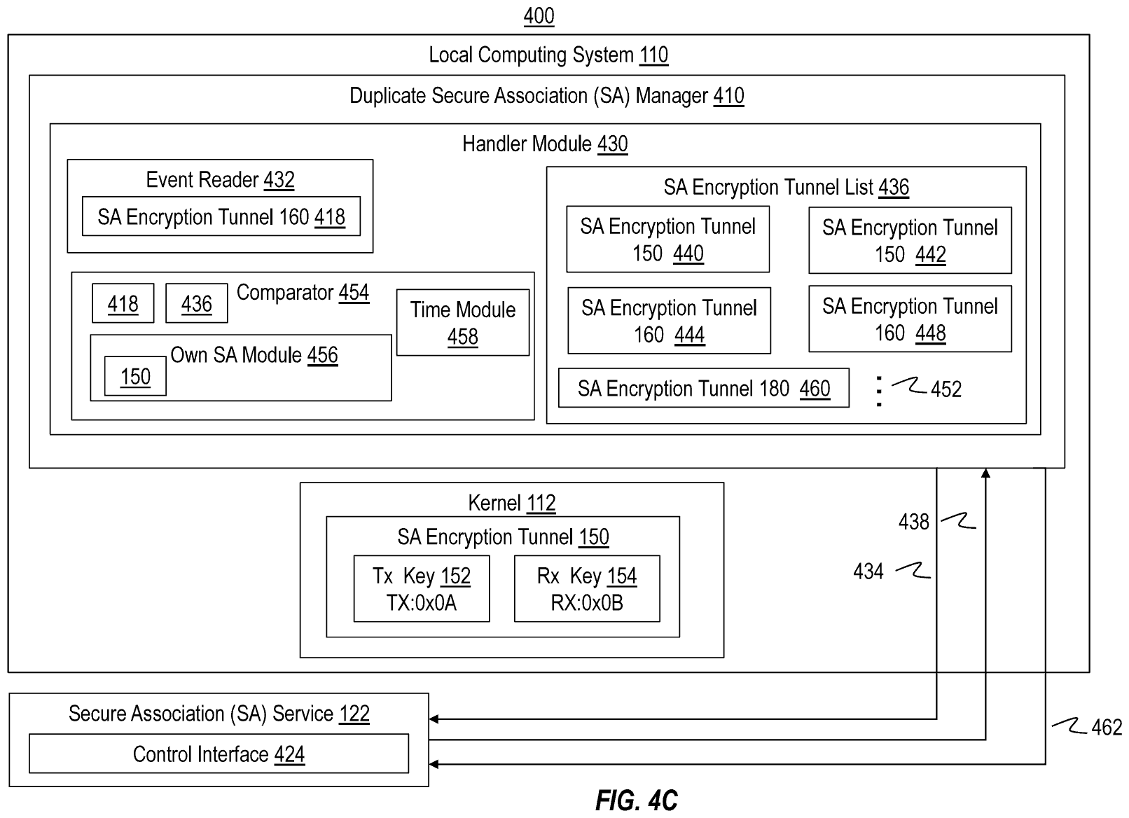

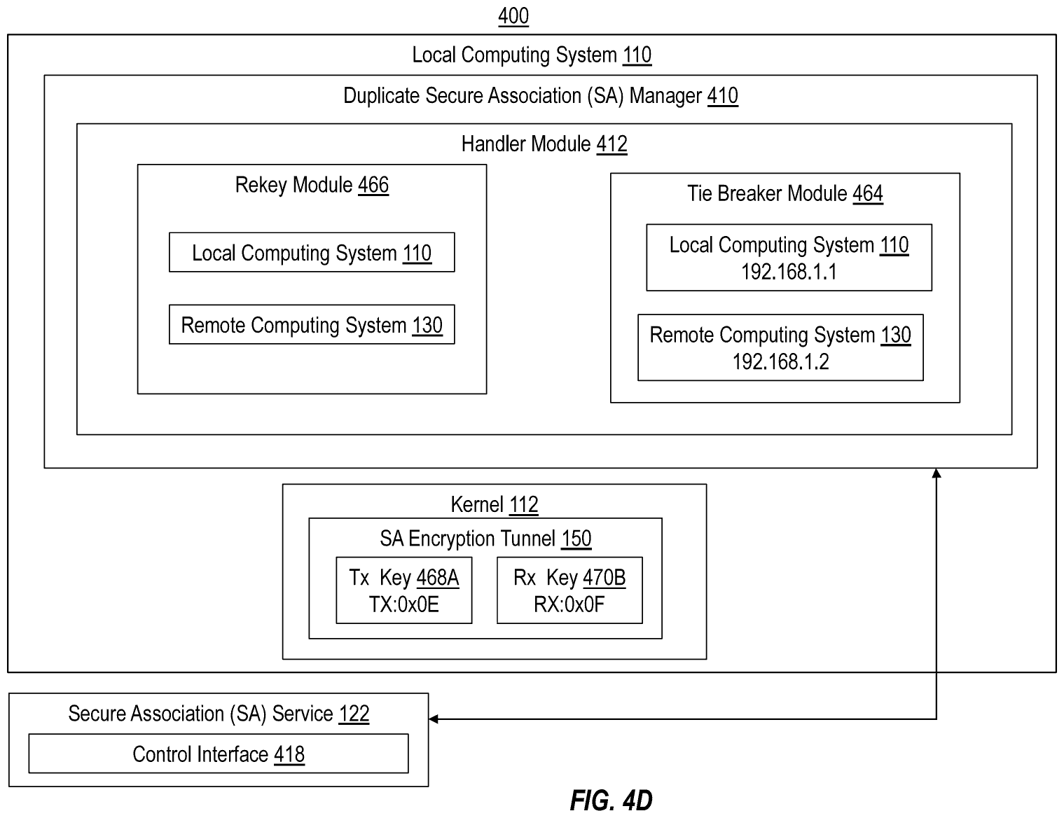

FIG. 4A illustrates an embodiment of a computing environment 400, which may correspond to the computing environment 100 previously described. As shown, computing environment 400 includes the local computing system 110. Although not shown, the computing environment 400 also includes the remote computing systems 130 and 142 and may also include any number of additional computing systems. In the embodiment, the kernel 112 includes the SA encryption tunnel 150 and the SA encryption tunnel 160, thus showing that the local computing system 110 is subject to the duplicate SA problem.

To solve the duplicate SA problem, the local computing system 110 includes a duplicate secure association (SA) manger 410. Although the following explanation will focus on the duplicate SA manger 410 of the local computing system 110, it will be appreciated that the remote computing systems 130 and 142, along with any other computing system of the computing environment 400, will also have a duplicate SA manger that work in conjunction with the duplicate SA manager 410. Thus, the explanation of the duplicate SA manager 410 will apply to the other duplicate SA managers.

As shown in FIG. 4A, the duplicate SA manager 410 includes a listener module 412. In operation, the listener module 412 subscribes 426 to the SA service 122 to receive new SA encryption tunnel events that occur in the computing environment 400 that include the local computing system 110. That is, the subscription 426 requests that any time a new SA encryption tunnel is generated in the computing environment 400 that involves the local computing system 110, the listener module 412 will be informed of the new event. Accordingly, the listener module 412 receives 428 the new SA encryption tunnel events.

In some embodiments, the listener module 412 receives a JSON object for each new SA encryption tunnel event. In some embodiments, all interactions between the duplicate SA manger 410 and the SA service 122 are facilitated by a versatile control interface 424 that is part of or otherwise associated with the SA service 122. That is, the versatile control interface 424 is a socket that exposes the SA service 122 to the duplicate SA manger 410. It will be noted that once the subscription 426 is made to the SA service 122, the subscription will continually remain active unless the versatile control interface 424 is removed or the SA service 122 is removed or no longer operable.

The listener module 412 includes or otherwise has access to a queue 414. Whenever the listener module 412 receives a new SA encryption tunnel event involving the local computing system 110, the listener module 412 writes the event to the queue 414. For example, the listener module 412 writes an event 416 for the SA encryption tunnel 150 generated by the local computing system 110, writes an event 418 for the SA encryption tunnel 160 generated by the remote computing system 130, and writes an event 420 for an SA encryption tunnel 170 that is generated by the remote computing system 142 between the local computing system 110 and the remote computing system 142. The ellipses 422 represent that the listener module 412 may write any number of additional events in the queue 414 that are provided by the versatile control interface 424 when an SA encryption tunnel is generated involving the local computing system 110. Thus, the listener module 412 will continually write any new SA encryption tunnel events involving the local computing system 110 to the queue 414 as they are received 428 from the versatile control interface 424.

As shown in FIG. 4B, the duplicate SA manager 410 further includes a handler module 430. In some embodiments, the handler module 430 is activated whenever a new SA encryption tunnel event is written by the listener module 412 in queue 414.

The handler module 430 includes an event reader 432. In operation, the event reader 432 reads the queue 414 for any new encryption tunnel events. It will be noted that since most SA encryption tunnels are generated around reboot or at the start of an appliance life cycle, in some embodiments the queue 414 may be empty for periods of time when there are no new encryption tunnel events in the environment.

When there are new encryption tunnel events in the queue 414, the event reader 432 will read each encryption tunnel event one at a time. The encryption tunnel event that is currently being read by the event reader 432, which will be the current event, will then be processed by the handler module before the next encryption tunnel event is read as will be explained. For example, suppose at a first time period the event reader 432 reads the event 416 for the SA encryption tunnel 150 as this is the first event in the queue 414. Thus, the event 416 will be the current event that will be processed before the other events are read.

The handler module 430 will then, at the first time period, make a request 434 to the versatile control interface 424 for an SA encryption tunnel list 436. The SA encryption tunnel list 436 is generated by the SA service 122 and provided 438 to the handler module 430 by the versatile control interface 424. The SA encryption tunnel list 436 is a list of all the active SA encryption tunnels including their encryption/decryption keys and the IP addresses assigned to the encryption/decryption keys on all the computing systems of the computing environment 400.

For example, as shown in FIG. 4B, the SA encryption tunnel list 436 includes an entry 440 for the SA encryption tunnel 150 of the local computing system 110, an entry 442 for the SA encryption tunnel 150 of the remote computing system 130, an entry 444 for the SA encryption tunnel 160 of the local computing system 110, an entry 448 for the SA encryption tunnel 160 of the remote computing system 130, and an entry 450 for the SA encryption tunnel 170 of the remote computing system 142. The ellipses 452 illustrate that the SA encryption tunnel list 436 may include any number of additional active SA encryption tunnels.

The handler module further includes a comparator 454. During the first time period, the comparator 454 compares the SA encryption tunnel 150 of the event 416 with the SA encryption tunnels listed on the SA encryption tunnel list 436 obtained during the first time period to determine if there are any duplicate SA encryption tunnels. During the comparison, the comparator 454 determines if the SA encryption tunnel 150 is a duplicate SA encryption tunnel. That is, the comparator 454 compares the SA encryption tunnel 150 with all the SA encryption tunnels listed in the SA encryption tunnel list 436 to determine if the TX key 152 and the RX key 154 of the SA encryption tunnel 150 that are associated with the IP address of the local computing system 110 are also associated with an IP address of one or more computing systems associated with the SA encryption tunnels listed in the SA encryption tunnel list 436. Thus, in some embodiments, the SA encryption tunnel 150 is a duplicate when it has encryption and decryption keys that are also assigned to an IP address of a computing system associated with one or more SA encryption tunnels included in the SA encryption tunnel list 436. In the embodiment, the SA encryption tunnel list 436 includes the entry 440 for the SA encryption tunnel 150 of the local computing system 110 and the entry 442 for the SA encryption tunnel 150 of the remote computing system 130, which both have TX encryption keys 152 and 154 and RX decryption keys 152 and 154 associated with the IP address of the local computing system 110 and the remote computing system 130.

As will be explained in more detail to follow, once a duplicate SA encryption tunnel is found by the comparator 454, a request to delete the duplicate SA encryption tunnel may be made to the SA service 122. However, the comparator 454 also includes an own SA module 456. In operation, the own SA module 456 determines if the found duplicate SA encryption tunnel is one that was generated by the computing system hosting the duplicate SA manager 410. In the embodiment of FIG. 4B, the found duplicate SA encryption tunnel 150 is the “own” SA encryption tunnel of the local computing system 110 since the SA encryption tunnel 150 was generated by the local computing system 110. Thus, the local computing system 110 intended for the SA encryption tunnel and its associated encryption and decryption keys to be generated and pushed into its kernel 112 and to also be generated and pushed into the kernel 132 of the remote computing system 130 so that the two computing system could transmit and receive encrypted network packages. Thus, the own SA module 456 will prevent the request to delete the duplicate SA encryption tunnel from being made to the SA service 122.

FIG. 4C illustrates that at a second time period the event reader 432 reads the event 418 for the SA encryption tunnel 160 as this is the second event in the queue 414. Thus, the event 418 is now the current event that will be processed before the other events are read.

The handler module 430 will, at the second time period, make the request 434 to the versatile control interface 424 for the SA encryption tunnel list 436, which is generated by the SA service 122 and provided 438 to the handler module 430 by the versatile control interface 424. It will be noted that the request 434 is made each time the event reader 432 reads the next event in the queue 414. Accordingly, the SA encryption tunnel list 436 may change each time that it is provided 438 to the handler module 430 as changes are being made to the SA encryption tunnels in the computing environment 400. Thus, in the embodiment of FIG. 4C the SA encryption tunnel list 436 now includes an entry 460 for an SA encryption tunnel 180 of a remote computing system and no longer includes the entry 450 for the SA encryption tunnel 170 of the remote computing system 142, which shows the changes in the computing environment 400 during the second time period.

During the second time period, the comparator 454 compares the SA encryption tunnel 160 of the event 418 for with the SA encryption tunnel list 436 obtained during the second time period. During the comparison, the comparator 454 determines that the SA encryption tunnel 160 is a duplicate since the SA encryption tunnel list 436 includes the entry 444 for the SA encryption tunnel 160 of the local computing system 110 and the entry 448 for the SA encryption tunnel 160 of the remote computing system 130, which both have TX encryption keys 156 and 158 and RX decryption keys 156 and 158 associated with the IP address of the local computing system 110 and the remote computing system 130. Once the duplicate SA encryption tunnel 160 is found by the comparator 454, the own SA module 456 determines that the found duplicate SA encryption tunnel 160 is not its own SA encryption tunnel since the duplicate SA encryption tunnel 160 was not generated by the local computing system 110.

Accordingly, a request 462 to delete the duplicate SA encryption tunnel 160 is made to the SA service 122 via the versatile control interface 424. In response to the request 462, the SA service 122 will cause that the SA encryption tunnel 160 is deleted in the kernel 112 of the local computing system 110 and the kernel 132 of the remote computing system 130. This is shown in FIG. 4C where the kernel 112 only includes the SA encryption tunnel 150. This results in the removal of the duplicate SA problem for the local computing system 110 and the remote computing system 130 since there will now be only one pair of encryption/decryption keys associated with the IP address of the local computing system 110 and the remote computing system 130.

In some embodiments, the SA service 122 performs a rekey operation on existing SA encryption tunnel using the process of FIG. 2 or 3. The rekey operation may be performed at a given time interval such as every hour. This results in new encryption/decryption keys, thus enhancing the security and operation of the computing environment. When the rekey operation, sometimes the old encryption/decryption keys, although no longer active, are retained in the kernel of a computing system. This may lead to the SA encryption tunnels of the old encryption/decryption keys being included in the SA encryption tunnel list 436 and being the basis of the comparator 454 finding a duplicate SA encryption tunnel. However, since the old encryption/decryption keys are inactive, there is no actual duplicate SA encryption tunnel.

Accordingly, to prevent the SA encryption tunnels of the old encryption/decryption keys being the basis of finding a duplicate SA encryption tunnel, in some embodiments the comparator 454 includes a time module 458. In operation, the time module 458 determines if the found duplicate SA encryption tunnel existed longer than a given time period from when the current event being handled by the comparator 454 occurred. If the found duplicate SA encryption tunnel existed longer than the given time period when the current event occurred, the comparator 454 assumes that a rekey process has occurred and the found duplicate SA encryption tunnel is ignored. In this way, SA encryption tunnels that are not really duplicates, but are only found to be duplicates because of the old encryption/decryption keys are not inadvertently deleted. In addition, computing resources are not wasted on the false duplicate SA encryption tunnels. Since most duplicate SA encryption tunnels are generated with ¼ second of each other and since a rekey operation occurs every hour, in one embodiment the given time period is set to 5 seconds as this time period should capture all real duplicate SA encryption tunnels while avoiding any false duplicates.

As mentioned previously, the remote computing system 130 will also have a duplicate SA manger that is able to find duplicate SA encryption tunnels and then request that the SA service 122 delete the duplicate SA encryption tunnels. Thus, there may be instances when both the duplicate SA manger 410 and the duplicate SA manager of the remote computing system 130 find a duplicate SA encryption tunnel. For example, both could find a duplicate SA encryption tunnel 150 or 160. In such instance, it would be a waste of computing resources for both the duplicate SA manger 410 and the duplicate SA manager of the remote computing system 130 to perform the process that results in the deletion of the duplicate SA encryption tunnel.

Accordingly, as illustrated in FIG. 4D, in some embodiments the handler module 412 includes a tie breaker module 464. In operation, the breaker module 464 determines which of the computing systems has a higher IP address and then designates that computing system as the one that will perform the process that results in the deletion of the duplicate SA encryption tunnel. This is then transmitted to the SA service 122. In the embodiment, the local computing system 110 has an IP address of 192.168.1.1 and the remote computing system 130 has an IP address of 192.168.1.2. Thus, the breaker module 464 determines that the local computing system 110 has the higher IP address and it will be designated to perform the process that results in the deletion of the duplicate SA encryption tunnel. Similarly, a tie breaker module of the duplicate SA manager of the remote computing system 130 will determine that the local computing system 110 has the higher IP address and thus will not designate the remote computing system 130 to perform the process that results in the deletion of the duplicate SA encryption tunnel.

In some embodiments it has been determined that a rekey process is beneficial for a surviving SA encryption tunnel after the duplicate SA encryption tunnel has been deleted as this enhances system performance. Accordingly, as illustrated in FIG. 4D, in some embodiments the handler module 412 includes a rekey module 466. In operation, the rekey module 466 determines that the duplicate SA encryption tunnel has been deleted. In response to this determination, the rekey module prompts the SA service 122 to perform the process of FIG. 2 to thereby generate new encryption/decryption keys for the SA encryption tunnel 150. As illustrated, this results in a new TX key 468 and a new RX key 470 being pushed to the kernel 112. Although not illustrated, a corresponding TX key 470 and a corresponding RX key 468 would be pushed to the kernel 132 of the remote computing system 130.

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

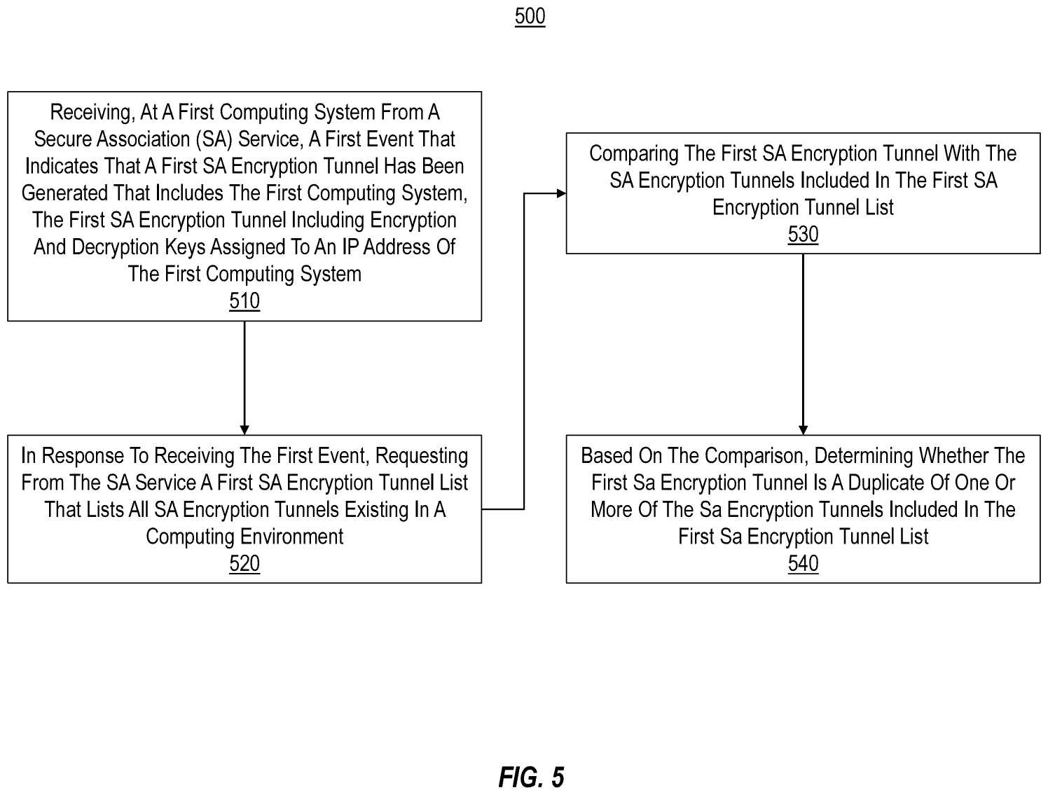

Directing attention now to FIG. 5, an example method 500 is disclosed. The method 500 will be described in relation to one or more of the figures previously described, although the method 500 is not limited to any particular embodiment.

The method 500 includes receiving, at a first computing system from a secure association (SA) service, a first event that indicates that a first SA encryption tunnel has been generated that includes the first computing system, the first SA encryption tunnel including encryption and decryption keys assigned to an IP address of the first computing system (510). For example, as previously described the listener module 412 of the duplicate SA manager 410 receives the events 416, 418, and 420 of the SA encryption tunnels 150, 160, and 170 and stores them in the queue 414. The SA encryption tunnels include the TX and RX encryption and decryption keys as previously discussed.

The method 500 includes in response to receiving the first event, requesting from the SA service a first SA encryption tunnel list that lists all SA encryption tunnels existing in a computing environment (520). For example, as previously handler module 430 of the duplicate SA manger 410 requests the SA encryption tunnel list 436 form the SA service 122.

The method 500 includes comparing the first SA encryption tunnel with the SA encryption tunnels included in the first SA encryption tunnel list (530). For example, as previously described the comparator 454 compares SA encryption tunnel 150 or 160 with the SA encryption tunnel list 436.

The method 500 includes based on the comparison, determining whether the first SA encryption tunnel is a duplicate of one or more of the SA encryption tunnels included in the first SA encryption tunnel list (540). For example, as previously described the comparator 454 determines if the SA encryption tunnel 150 or 160 is a duplicate in the manner previously described.

Following are some further example embodiments of the invention. These are presented only by way of example and are not intended to limit the scope of the invention in any way.

Embodiment 1. A method, comprising: receiving, at a first computing system from a secure association (SA) service, a first event that indicates that a first SA encryption tunnel has been generated that includes the first computing system, the first SA encryption tunnel including encryption and decryption keys assigned to an IP address of the first computing system; in response to receiving the first event, requesting from the SA service a first SA encryption tunnel list that lists all SA encryption tunnels existing in a computing environment; comparing the first SA encryption tunnel with the SA encryption tunnels included in the first SA encryption tunnel list; and based on the comparison, determining whether the first SA encryption tunnel is a duplicate of one or more of the SA encryption tunnels included in the first SA encryption tunnel list.

Embodiment 2. The method as recited in embodiment 1, further comprising: receiving, at the first computing system from the SA service, a second event that indicates that a second SA encryption tunnel has been generated that includes the first computing system, the second SA encryption tunnel including encryption and decryption keys assigned to the IP address of the first computing system; in response to receiving the second event, requesting from the SA service a second SA encryption tunnel list that lists all SA encryption tunnels existing in the computing environment; comparing the second SA encryption tunnel with the SA encryption tunnels included in the second SA encryption tunnel list; and based on the comparison, determining whether the second SA encryption tunnel is a duplicate of one or more of the SA encryption tunnels included in the second SA encryption tunnel list.

Embodiment 3. The method as recited in embodiments 1-2, further comprising: deleting, by the SA service, the first SA encryption tunnel when it is determined that the first SA encryption tunnel is a duplicate.

Embodiment 4. The method as recited in any of embodiments 1-3, further comprising: determining that the first SA encryption tunnel has been generated by the first computing system; and in response, not deleting the first SA encryption tunnel even if the first SA encryption tunnel is determined to be a duplicate.

Embodiment 5. The method as recited in any of embodiments 1-4, further comprising: determining that the first computing system has a higher IP address than the second computing system; and in response, designating the first computing system to determine that the first SA encryption tunnel should be deleted when the first SA encryption tunnel is determined to be a duplicate.

Embodiment 6. The method as recited in any of embodiments 1-5, further comprising: after determining that the first SA encryption tunnel is a duplicate, determining if the first SA encryption tunnel existed longer than a given time period from when the first event occurred; if the first SA encryption tunnel is determined to have existed longer than the given time period from when the first event occurred, determining that a rekey process involving the first computing system has occurred; and in response, not deleting the first SA encryption tunnel.

Embodiment 7. The method as recited in any of embodiments 1-6, further comprising: deleting, by the SA service, the first SA encryption tunnel when it is determined that the first SA encryption tunnel is a duplicate; and performing a rekey process on any SA encryption tunnels that are still associated with the first computing system.

Embodiment 8. A system, comprising hardware and/or software, operable to perform any of the operations, methods, or processes, or any portion of any of these, disclosed herein.

Embodiment 9. A non-transitory storage medium having stored therein instructions that are executable by one or more hardware processors to perform operations comprising the operations of any one or more of embodiments 1-7.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that are executed on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to conduct executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

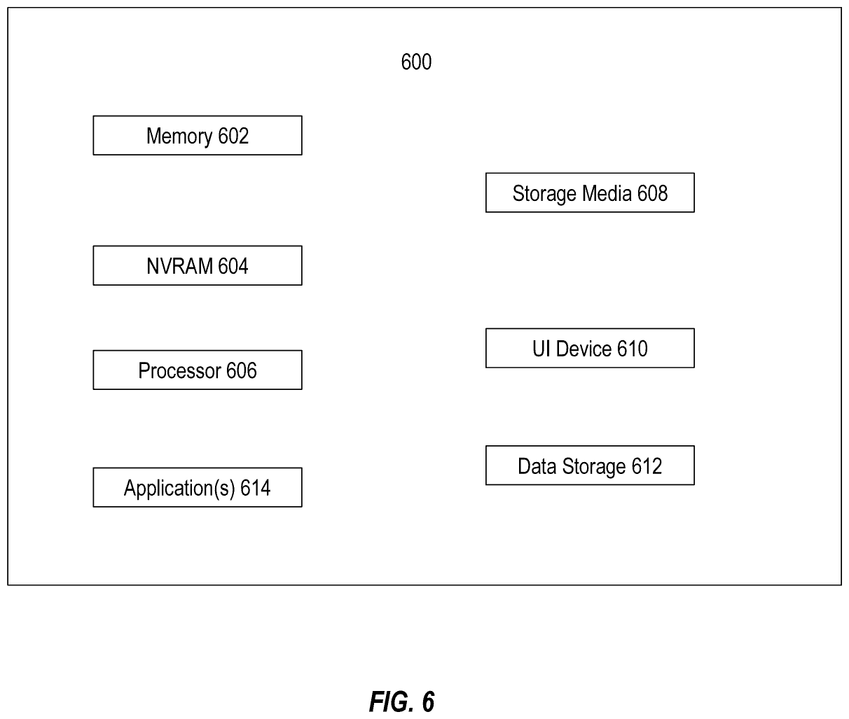

With reference briefly now to FIG. 6, any one or more of the entities disclosed, or implied, by FIGS. 1A-5, and/or elsewhere herein, may take the form of, or include, or be implemented on, or hosted by, a physical computing device, one example of which is denoted at 600. As well, where any of the aforementioned elements comprise or consist of a virtual machine (VM), that VM may constitute a virtualization of any combination of the physical components disclosed in FIG. 6.

In the example of FIG. 6, the physical computing device 600 includes a memory 602 which may include one, some, or all, of random access memory (RAM), non-volatile memory (NVM) 604 such as NVRAM for example, read-only memory (ROM), and persistent memory, one or more hardware processors 606, non-transitory storage media 608, UI device 610, and data storage 612. One or more of the memory components 602 of the physical computing device 600 may take the form of solid state device (SSD) storage. As well, one or more applications 614 May be provided that comprise instructions executable by one or more hardware processors 606 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
receiving, at a first computing system from a secure association (SA) service, a first event that indicates that a first SA encryption tunnel has been generated that includes the first computing system, the first SA encryption tunnel including encryption and decryption keys assigned to an IP address of the first computing system;
in response to receiving the first event, requesting from the SA service a first SA encryption tunnel list that lists all SA encryption tunnels existing in a computing environment;
comparing the first SA encryption tunnel with the SA encryption tunnels included in the first SA encryption tunnel list; and
based on the comparison, determining whether the first SA encryption tunnel is a duplicate of one or more of the SA encryption tunnels included in the first SA encryption tunnel list.

2. The method of claim 1, further comprising:
receiving, at the first computing system from the SA service, a second event that indicates that a second SA encryption tunnel has been generated that includes the first computing system, the second SA encryption tunnel including encryption and decryption keys assigned to the IP address of the first computing system;
in response to receiving the second event, requesting from the SA service a second SA encryption tunnel list that lists all SA encryption tunnels existing in the computing environment;
comparing the second SA encryption tunnel with the SA encryption tunnels included in the second SA encryption tunnel list; and
based on the comparison, determining whether the second SA encryption tunnel is a duplicate of one or more of the SA encryption tunnels included in the second SA encryption tunnel list.

3. The method of claim 1, further comprising:
deleting, by the SA service, the first SA encryption tunnel when it is determined that the first SA encryption tunnel is a duplicate.

4. The method of claim 1, further comprising:
determining that the first SA encryption tunnel has been generated by the first computing system; and
in response, not deleting the first SA encryption tunnel even if the first SA encryption tunnel is determined to be a duplicate.

5. The method of claim 1, further comprising:
determining that the first computing system has a higher IP address than a second computing system; and
in response, designating the first computing system to determine that the first SA encryption tunnel should be deleted when the first SA encryption tunnel is determined to be a duplicate.

6. The method of claim 1, further comprising:
after determining that the first SA encryption tunnel is a duplicate, determining if the first SA encryption tunnel existed longer than a given time period from when the first event occurred;
if the first SA encryption tunnel is determined to have existed longer than the given time period from when the first event occurred, determining that a rekey process involving the first computing system has occurred; and
in response, not deleting the first SA encryption tunnel.

7. The method of claim 1, further comprising:
deleting, by the SA service, the first SA encryption tunnel when it is determined that the first SA encryption tunnel is a duplicate; and
performing a rekey process on any SA encryption tunnels that are still associated with the first computing system.

8. A computing system comprising:
one or more processors;
a non-transitory computer readable medium having stored thereon instructions that when executed by the one or more processors cause the computing system to perform the following:
receive, at a first computing system from a secure association (SA) service, a first event that indicates that a first SA encryption tunnel has been generated that includes the first computing system, the first SA encryption tunnel including encryption and decryption keys assigned to an IP address of the first computing system;
in response to receiving the first event, request from the SA service a first SA encryption tunnel list that lists all SA encryption tunnels existing in a computing environment;
compare the first SA encryption tunnel with the SA encryption tunnels included in the first SA encryption tunnel list; and
based on the comparison, determine whether the first SA encryption tunnel is a duplicate of one or more of the SA encryption tunnels included in the first SA encryption tunnel list.

9. The computing system of claim 8, the computing system further caused to:
receive, at the first computing system from the SA service, a second event that indicates that a second SA encryption tunnel has been generated that includes the first computing system, the second SA encryption tunnel including encryption and decryption keys assigned to the IP address of the first computing system;
in response to receiving the second event, request from the SA service a second SA encryption tunnel list that lists all SA encryption tunnels existing in the computing environment;
compare the second SA encryption tunnel with the SA encryption tunnels included in the second SA encryption tunnel list; and
based on the comparison, determine whether the second SA encryption tunnel is a duplicate of one or more of the SA encryption tunnels included in the second SA encryption tunnel list.

10. The computing system of claim 8, the computing system further caused to:
delete, by the SA service, the first SA encryption tunnel when it is determined that the first SA encryption tunnel is a duplicate.

11. The computing system of claim 8, the computing system further caused to:
determine that the first SA encryption tunnel has been generated by the first computing system; and
in response, not delete the first SA encryption tunnel even if the first SA encryption tunnel is determined to be a duplicate.

12. The computing system of claim 8, the computing system further caused to:
determine that the first computing system has a higher IP address than a second computing system; and
in response, designate the first computing system to determine that the first SA encryption tunnel should be deleted when the first SA encryption tunnel is determined to be a duplicate.

13. The computing system of claim 8, the computing system further caused to:
after determining that the first SA encryption tunnel is a duplicate, determine if the first SA encryption tunnel existed longer than a given time period from when the first event occurred;
if the first SA encryption tunnel is determined to have existed longer than the given time period from when the first event occurred, determine that a rekey process involving the first computing system has occurred; and
in response, not delete the first SA encryption tunnel.

14. The computing system of claim 8, the computing system further caused to:
delete, by the SA service, the first SA encryption tunnel when it is determined that the first SA encryption tunnel is a duplicate; and
perform a rekey process on any SA encryption tunnels that are still associated with the first computing system.

15. A non-transitory storage medium having stored therein instructions that are executable by one or more hardware processors to perform operations comprising:
receive, at a first computing system from a secure association (SA) service, a first event that indicates that a first SA encryption tunnel has been generated that includes the first computing system, the first SA encryption tunnel including encryption and decryption keys assigned to an IP address of the first computing system;
in response to receiving the first event, request from the SA service a first SA encryption tunnel list that lists all SA encryption tunnels existing in a computing environment;
compare the first SA encryption tunnel with the SA encryption tunnels included in the first SA encryption tunnel list; and
based on the comparison, determine whether the first SA encryption tunnel is a duplicate of one or more of the SA encryption tunnels included in the first SA encryption tunnel list.

16. The non-transitory storage medium of claim 15, further comprising:
receive, at the first computing system from the SA service, a second event that indicates that a second SA encryption tunnel has been generated that includes the first computing system, the second SA encryption tunnel including encryption and decryption keys assigned to the IP address of the first computing system;
in response to receiving the second event, request from the SA service a second SA encryption tunnel list that lists all SA encryption tunnels existing in the computing environment;
compare the second SA encryption tunnel with the SA encryption tunnels included in the second SA encryption tunnel list; and
based on the comparison, determine whether the second SA encryption tunnel is a duplicate of one or more of the SA encryption tunnels included in the second SA encryption tunnel list.

17. The non-transitory storage medium of claim 15, further comprising:
delete, by the SA service, the first SA encryption tunnel when it is determined that the first SA encryption tunnel is a duplicate.

18. The non-transitory storage medium of claim 15, further comprising:
determine that the first SA encryption tunnel has been generated by the first computing system; and
in response, not delete the first SA encryption tunnel even if the first SA encryption tunnel is determined to be a duplicate.

19. The non-transitory storage medium of claim 15, further comprising:
determine that the first computing system has a higher IP address than a second computing system; and
in response, designate the first computing system to determine that the first SA encryption tunnel should be deleted when the first SA encryption tunnel is determined to be a duplicate.

20. The non-transitory storage medium of claim 15, further comprising:
after determining that the first SA encryption tunnel is a duplicate, determine if the first SA encryption tunnel existed longer than a given time period from when the first event occurred;
if the first SA encryption tunnel is determined to have existed longer than the given time period from when the first event occurred, determine that a rekey process involving the first computing system has occurred; and
in response, not delete the first SA encryption tunnel.
